(19) United States
(12) Patent Application Publication
(10) Pub. No.: US 2002/0134434 A1
(43) Pub. Date: Sep. 26, 2002

(54) Valve, particularly for compressors, with valve face having a shaped profile

(76) Inventors: Massimo Schiavone, Carrara (IT); Andrea Bianchi, Massa (IT)

Correspondence Address: LARSON & TAYLOR, PLC, 1199 NORTH FAIRFAX STREET, SUITE 900, ALEXANDRIA, VA, 22314, US

(21) Appl. No.: 10/069,619

(22) PCT Filed: Jun. 1, 2001
(86) PCT No.: PCT/EP01/06266

(30) Foreign Application Priority Data
Jun. 30, 2000 (IT) GE-2000A089

(51) Int. Cl. F16K 15/10

(52) U.S. Cl. 137/516.13

(57) ABSTRACT

Valve, preferably for compressors, comprising a seat (2; 4) in which there are formed one or more flow apertures (102; 104), positioned with their axes parallel to that of the said seat (2; 4), and a valve face member movable in a direction parallel to the axis of the said seat, comprising one or more valve face elements (1; 3) capable of interacting with the said apertures (102, 104) formed in the said seat (2; 4); each valve face element (1; 3) has, on the surface facing the said aperture (102; 104), a concave profile (111; 113) which is symmetrical with respect to the axis of the corresponding aperture.

The present invention relates to a valve, preferably a valve for compressors, and in particular to a valve provided with a valve face having a shaped profile.

Valves for compressors of the type currently in use are normally automatic valves consisting of a valve seat consisting of a plate in which a plurality of coaxial flow channels are formed; these can be concentric or non-concentric. In the case of concentric flow channels, the valve face is generally a member consisting of a plurality of essentially annular elements, which can have profiles with different characteristics; these valve faces are operated by springs which act in opposition to the pressures which are present. Rings with a flat profile have the best characteristics, in terms of the efficacy of sealing, because of the large sealing surface, and also in terms of the wear and deformation of the ring due, for example, to thermal excursions; additionally, flat rings generally provide a larger passage cross-section for a given valve lift. On the other hand, this type of valve face has a low fluid dynamic efficiency, due to the consistent turbulences which are formed in the flow when it encounters a flat surface.

U.S. Pat. No. 3,536,094 describes a valve for compressors in which the valve face consists of concentric rings having a surface which engages the channels of the convex valve seat. More generally, solutions similar to this one achieve a higher fluid dynamic efficiency, with lower pressure losses. However, in this type of ring, because the sealing surface is smaller than that of a flat ring, the effect of wear and deformation due to temperature variations can lead to losses of sealing, thus compromising the operation of the compressors in which the said valves are used. A similar solution to the problem is provided in U.S. Pat. No. 4,924,906.

The object of the present invention is therefore to provide a valve for compressors in which both the sealing characteristics and the fluid dynamic efficiency are optimized with respect to what is known in the prior art, thus improving the performance of the valve from both points of view and therefore providing better operation of the compressor in which the said valves are used.

According to a known fluid dynamic effect, called the Coanda effect after its discoverer, a turbulent fluid can easily be guided by pilot pressures due to flows acting on the fluid. The gaseous medium passing through a valve of known type is largely in a condition of turbulent motion, because of the numerous geometrical discontinuities which the gas encounters in passing through the valve channels.

The object of the present invention is therefore a valve, preferably for compressors, comprising a seat in which one or more flow apertures are formed, placed with their axes parallel to that of the said seat, and a valve face member, moveable along a direction parallel to the axis of said seat, comprising one or more valve face elements capable of interacting with the said apertures formed in the said seat, characterized in that each valve face element has, on its side facing the said apertures, a concave profile symmetrical about the axis of the corresponding aperture.

In a preferred embodiment, the said flow apertures are made coaxial and concentric, and the said valve face elements are annular elements.

Further advantages and characteristics of the device according to the present invention will be made clearer by the following detailed description of some embodiments thereof, provided by way of example and without restrictive intent, with reference to the attached sheets of drawings, in which:

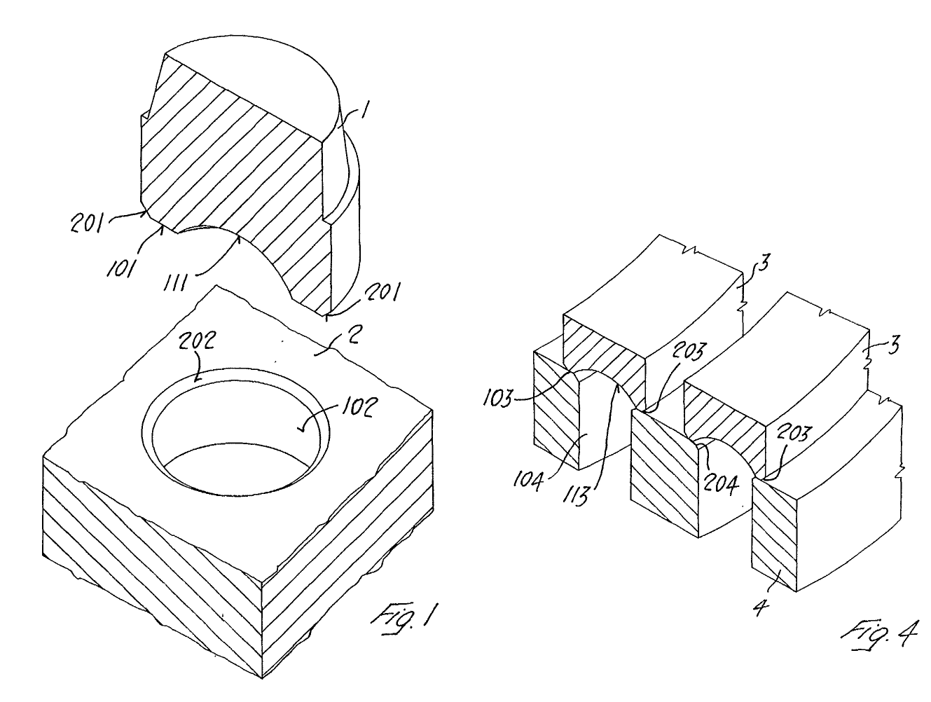

FIG. 1 is a perspective view, with parts in cross section, of a detail of a first embodiment of the valve according to the present invention;

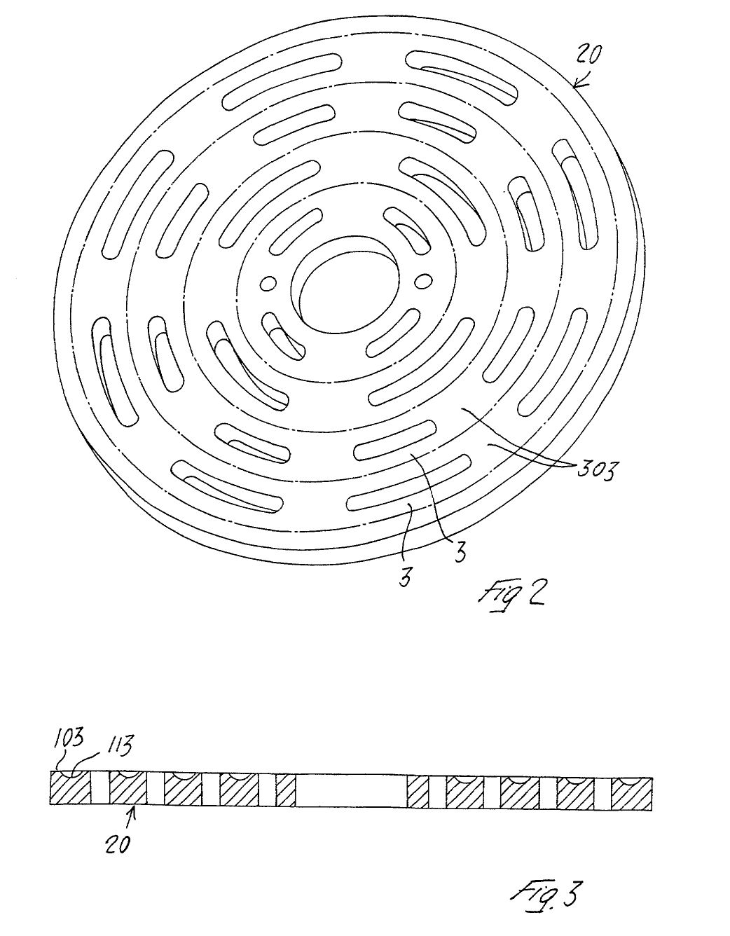

FIG. 2 is a perspective view of a disc-shaped valve face made according to the present invention;

FIG. 3 is a perspective view in cross section of the valve face illustrated in FIG. 2;

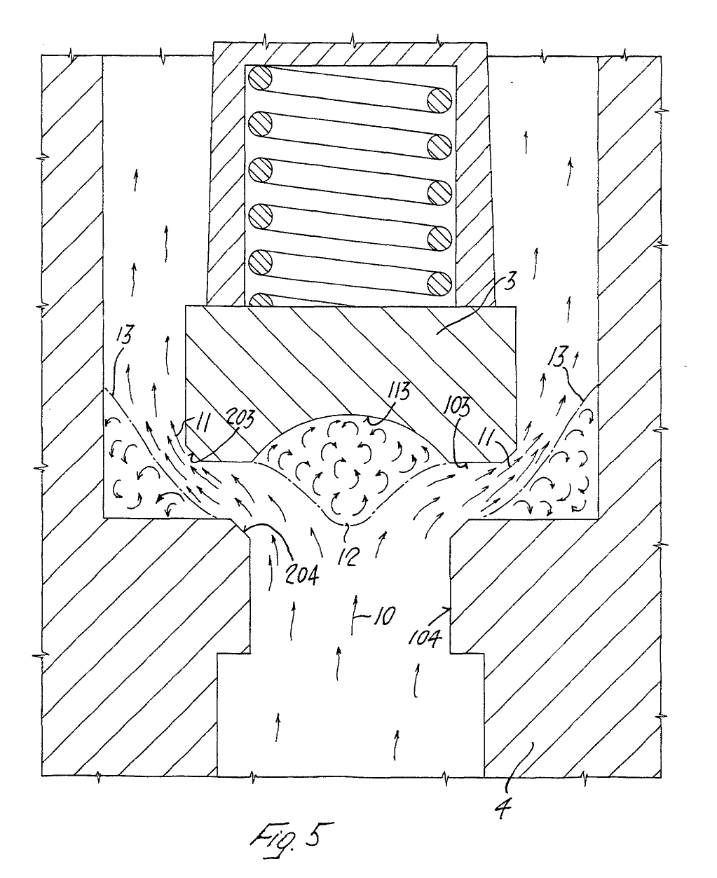

FIG. 4 is a perspective view of a valve face with rings made according to the present invention;

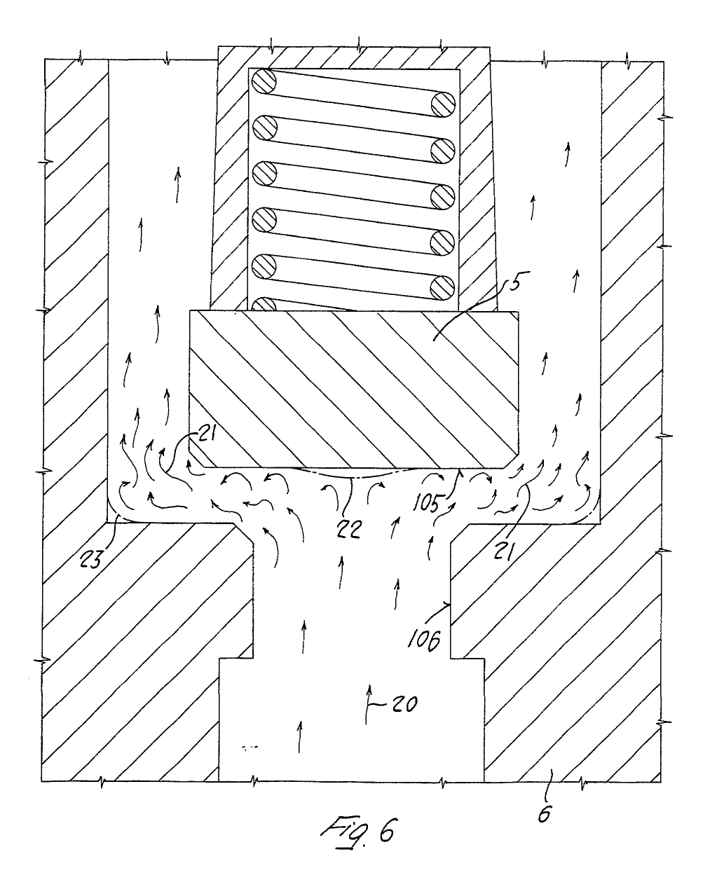

FIG. 5 is a schematic diagram relating to a flow analysis conducted on the valve model according to the present invention;

FIG. 6 is a schematic diagram relating to a flow analysis conducted on the valve model of the type with flat valve faces.

FIG. 1 is a schematic representation of a detail of the valve according to the invention; the number 1 indicates a valve face element, facing the valve seat 2 and movable in a direction parallel to the axis of the aperture 102 formed in the said seat. The surface of the element 1 facing the aperture 102 is a flat wall 101 on which is formed a cavity 111 which is symmetrical about the axis of the aperture 102 of the seat 2, and in this specific format is of the spherical cap type. A surface 201, tapered towards the end of the valve face facing the aperture 102, is formed along the outer perimetric edge of the wall 101 of the valve face element 1. Similarly, the surface 202 tapered towards the channel of the aperture 102 is formed on the output edge of the aperture 102.

FIG. 2 shows a disc-shaped valve face 20 similar to those of known types used in valves for compressors; the annular elements 3 are connected together by the links 303. In FIG. 3, the valve face 20 is shown in cross section, and the flat sealing wall 103 of the annular elements 3 and the concavity 113 formed in it are visible.

FIG. 4 shows a detail of the valve with the ring-type valve faces according to the present invention; the number 4 indicates the valve seat in which are formed the apertures 104, which are annular, coaxial and concentric with each other. The valve face elements consist of the rings 3, such as those illustrated in FIG. 2, portions of which are shown in the figure; the rings 3, which are coaxial and concentric with each other, have a flat wall 103, providing a seal against the seat 4, on the side facing the corresponding apertures 104; a cavity 113, symmetrical about the axis of the aperture 104 and having a concave cross section, is formed in the said wall. The outer peripheral edge of the wall 103 has a surface 203; similarly, the outer peripheral edge of the aperture 104 has a surface 204 tapered towards the interior of the aperture.

The operation of the valve according to the invention will be made clear with the aid of the attached FIGS. 5 and 6. FIG. 5 shows schematically a two-dimensional flow analysis of a valve according to the present invention; the reference numerals assigned to it correspond to those of the embodiment shown in FIG. 4; the simulation was carried out by modelling a channel and the corresponding valve face ring and assuming an incoming air flow with a velocity of 10 m/s and a downstream outlet into the atmosphere. As can be seen, in the area of the cavity 113 of the valve face element, in other words the ring 3, a kind of gas cushion 12 is formed, originating from the flow 10 entering from the aperture 104. This cushion 12 promotes the formation of the two main lines of flow 11 at the sides of the valve face element 3. Consequently, pockets are formed in the two areas at the sides of the aperture 104, thus effectively limiting the tortuousness of the path of the lines 11 and allowing a faster flow. In practice, the gas cushion 12 acts in a similar way to a convex profile facing the aperture 104 of the seat 4, but without having the disadvantages of such a profile. This is because the seal between the seat 4 and the valve face element 3 is formed by the contact of the seat with the flat wall 103 of the valve face element, thus avoiding the typical problems of valve faces of the convex ring type, associated with deformation, wear and thermal excursions, and with the limited dimensions of the sealing surface.

Advantageously, the tapered surfaces 203 of the valve face element and the tapered surface 204 of the aperture make the path of the lines of flow 11 smoother and less turbulent.

The valve face, whether of the type illustrated in the embodiment of FIG. 1 or of the type illustrated in FIGS. 2 and 4, can be made from thermoplastic material; in particular, if materials with good mechanical properties, such as polyether ether ketones (PEEK™) filled with glass fibre, carbon or the like.

FIG. 6 illustrates, as a reference, a test similar to that of FIG. 5, conducted on a valve provided with a valve face 5 whose surface facing the aperture 106 of the seat 6 has only the flat wall 105. This valve face ring 5 has the same sealing characteristics as the ring 3 of the valve according to the invention, but the analysis of the gas flow in the valve channels reveals rather different results. This is because, as shown in the figure, the gas flow 20 encounters the flat wall 105, on which a gas cushion 22 is formed which is small, especially when compared to that shown in FIG. 5; in this situation, the flows 21 have a rather more tortuous path, partially due to the narrowness of the areas 23 at the sides of the aperture 106, and therefore the pressure drops caused by these fluid dynamic deficiencies are rather accentuated, as stated at the outset.

The valve designed according to the present invention therefore provides good results in terms of fluid dynamics, with a significant containment of the pressure drops caused the typical turbulence in valves with flat valve faces, while simultaneously providing a sealing performance comparable with the latter type of valve.

1. Valve, preferably for compressors, comprising a seat (2; 4) in which there are formed one or more flow apertures (102; 104), positioned with their axes parallel to that of the said seat (2; 4), and a valve face member movable in a direction parallel to the axis of the said seat, comprising one or more valve face elements (1; 3) capable of interacting with the said apertures (102; 104) formed in the said seat (2; 4), characterized in that each valve face element (1; 3) has, on the surface facing the said aperture (102; 104), a concave profile (111; 113) which is symmetrical with respect to the axis of the corresponding aperture.

2. Valve according to claim 1, in which the said concave profile (111; 113) is formed on an essentially flat wall (101; 103) which is capable of providing a frontal seal in combination with the said seat (2; 4).

3. Valve according to claim 2, in which the said valve face element (1; 3) has, on the peripheral edge of the said flat wall (101; 103), a surface (201; 203) which is tapered towards the said flat wall (101; 103).

4. Valve according to claim 1 or 2, in which the said concave profile (111; 113) is shaped essentially as an arc of a circumference.

5. Valve according to any one of the preceding claims 2 to 4, in which the said aperture (102; 104) has, on its outlet edge, a surface (202; 204) tapered towards the opposite end of the said aperture (102; 104).

6. Valve according to any one of the preceding claims, in which the said flow apertures (104) are formed coaxially and concentrically in the said seat (4), and the said valve face elements are annular elements (3).

7. Valve according to any one of the preceding claims, in which the said flow apertures (104) are formed coaxially and concentrically in the said seat (4), and the valve face element consists of a disc in which are formed similar flow apertures and a set of concave profiles facing the seat (4), at the position of the flow apertures (4).

8. Valve according to any one of the preceding claims, in which the said valve face elements (1; 3) are made from material with good mechanical properties, such as polyether ether ketones (PEEK™) filled with glass fibre, carbon or the like.
